(19) United States
(12) Patent Application Publication
(10) Pub. No.: US 2025/0139061 A1
(43) Pub. Date: May 1, 2025

(54) METHOD FOR ACCESSING A SHARED MEMORY DATABASE, SERVER AND STORAGE MEDIUM

(71) Applicant: SHENZHEN ZOLON TECHNOLOGY CO., LTD., Shenzhen (CN)

(72) Inventor: JIAN WANG, Shenzhen (CN)

(21) Appl. No.: 18/724,637

(22) PCT Filed: Oct. 18, 2022
(86) PCT No.: PCT/CN2022/125977

§ 371 Date: Jan. 16, 2025

(30) Foreign Application Priority Data
Dec. 31, 2021 (CN) 202111679166.7

(51) Int. Cl. G06F 16/176; G06F 9/54; G06F 12/1072

(52) U.S. Cl. CPC G06F 16/176; G06F 9/544; G06F 12/1072

(57) ABSTRACT

A method for accessing a shared memory database applied to a server is provided. The method includes: invoking a API interface and obtaining an access request sent by an external program; sending an identification file in a database to the external program according to the access request, controlling the external program to wait to access a shared memory according to an identification value in the identification file; according to the identification value in the identification file, opening a channel for the external program to access the shared memory; mapping the shared memory to a virtual address space of the external program, and the database being loaded into the external program; controlling the database and the external program to perform a data interaction in the shared memory.

This application claims priority to Chinese Patent Application No. 202111679166.7 filed on Dec. 31, 2021, in China National Intellectual Property Administration, the contents of which are incorporated by reference herein.

### FIELD

The present application relates to a field of computer technology, and more particularly to a method, a device, a system for accessing a shared memory database, a server, and a storage medium.

### BACKGROUND

Currently, a socket communication mode is used to access to the memory database, namely when an application needs to access the memory database, it sends a request message to a memory database service process by a socket communication port. After receiving a socket request instruction, the memory database service process queries or modifies memory data, and then sends a processing result to the application by the socket communication port. After the application receives the processing result, the access to the memory database is completed.

The socket communication mode seriously restricts an access efficiency to an internal memory when deployed with a host. Generally speaking, an access speed of the process to the internal memory is generally within a few microseconds, and a speed of the socket communication is about 10 times slower than direct internal memory access due to a consumption of network I/O, a mutual waiting of two communication parties, etc. Since a processing time is mostly spent on communication, an advantage of “fast access to internal memory” cannot be fully and effectively utilized.

The prior art also has a method of directly putting the memory data into a shared memory using the memory database service process to speed up a speed at which the client accesses the database, but this requires the memory database service process to be online, which is not conducive to improving the performance of the computer.

### BRIEF DESCRIPTION OF THE DRAWINGS

In order to more clearly illustrate technical solutions in the embodiments of the present application, the drawings required for use in the embodiments or the description of the prior art will be briefly introduced below. Obviously, the drawings described below are only some embodiments of the present application. For ordinary technicians in this field, other drawings can be obtained according to these drawings without paying creative work.

FIG. 1 is a schematic flow chart of a method for accessing a shared memory database provided in an embodiment of the present application.

FIG. 2 is a schematic diagram of a database structure provided in an embodiment of the present application.

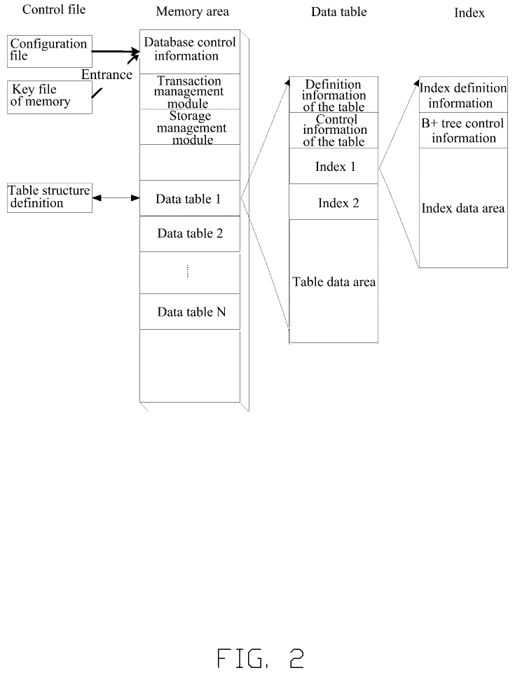

FIG. 3 is a schematic diagram of a database initialization process provided in an embodiment of the present application.

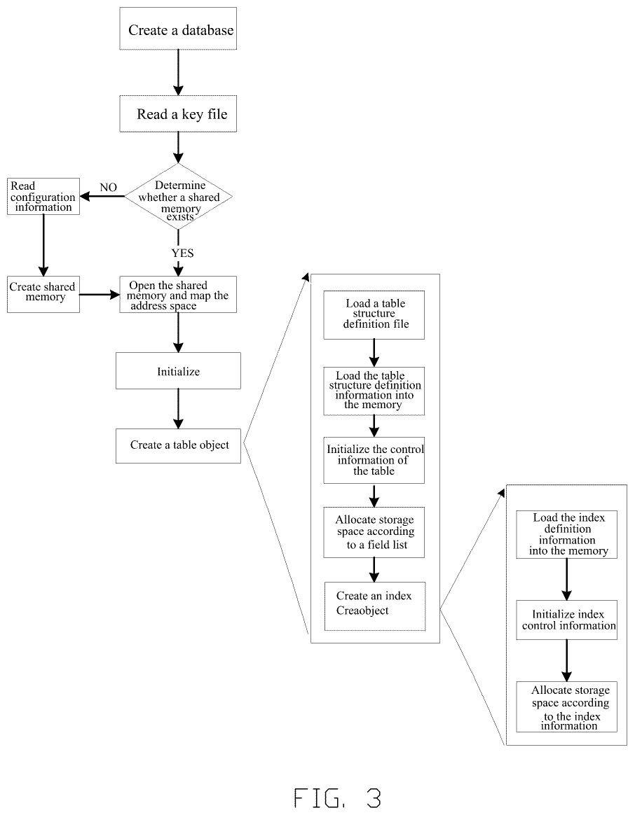

FIG. 4 is a schematic diagram of the logical structure of a device for accessing a shared memory database provided in an embodiment of the present application.

FIG. 5 is a schematic diagram of a logical structure of a shared memory database system provided in another embodiment of the present application.

### DETAILED DESCRIPTION

In the following description, in order to illustrate rather than to limit, specific details such as specific system structure, technology and the like are proposed, so as to thoroughly understand the present application embodiment. However, it should be clear to those skilled in the art that in other embodiments without these specific details, the present application can also be realized. In other cases, the detailed description of well-known system, device, circuit and method is omitted to avoid unnecessary details hindering the description of the present application.

It should be understood that when used in the present specification and the appended claims, the term “comprising” indicates the presence of described features, wholes, steps, operations, elements and/or components, but does not exclude the presence or addition of one or more other features, wholes, steps, operations, elements, components and/or collections thereof.

It should also be understood that the term “and/or” used in the present specification and the appended claims refers to any combination and all possible combinations of one or more of the associated listed items, and includes these combinations.

In addition, in the description of the present application specification and the appended claims, the terms “first”, “second”, “third”, etc. are only used to distinguish the descriptions and cannot be understood as indicating or implying relative importance.

Reference “one embodiment” or “some embodiments” etc. described in the present application specification sheet means to include in one or more embodiments of the specific features, structure or characteristics described in conjunction with the embodiment. Thus, the statements “in one embodiment”, “in some embodiments”, “in some other embodiments”, “in some other embodiments” etc. that appear in the difference in this specification sheet are not necessarily all with reference to the same embodiment, but mean “one or more but not all embodiments”, unless otherwise particularly emphasized in addition. Term “comprises”, “includes”, “has” and their deformation all mean “including but not limited to”, unless otherwise particularly emphasized in addition.

The technical solution of the present application is described below by means of specific embodiments.

### Embodiment 1

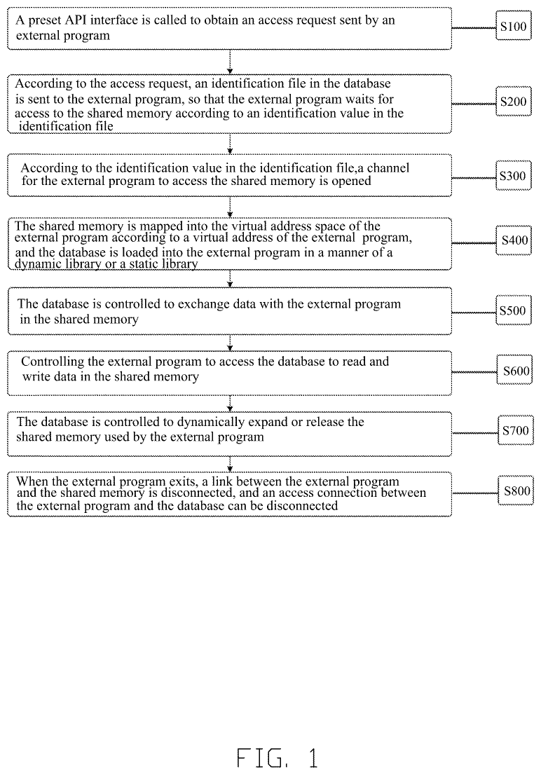

In a first aspect, as shown in FIG. 1, an embodiment of the present application provides a method for accessing a shared memory database, and the method is applied to a server and includes the following steps.
S100, a preset application programming interface (API) interface is called to obtain an access request sent by an external program.

In one embodiment, the API interface is an interface installed on a server and provided to external program applications. The API interface can be an API interface of a C/C++ language or a standard structured query language (SQL) interface.

Specifically, when the external program is started, the external program needs to access data in the shared memory database located at the server, and sends an access request, and the access request is received by the API interface at the server. In one embodiment, there is no restriction on the access request, and various modes and forms of access requests are accommodated.
S200, according to the access request, an identification file in the database is sent to the external program, so that the external program waits for access to the shared memory according to an identification value in the identification file.

In one embodiment, after receiving the access request sent by the external program, the server sends the identification file in the database to the external program, and a program of the external program waits for a confirmation of a shared memory identification value (namely identification value) in the identification file to access the shared memory. Preferably, the identification file can be set as a key file, and the shared memory identification value can be set as an identification key value. A specific key value setting is set according to the needs.

Further, in one embodiment, according to the access request, a step of sending the identification file in the database to the external program includes the following steps:
according to the access request, the server creating a database;
creating the identification file according to the database;
sending the identification file to the external program.

Specifically, if there is no database in the shared memory of the server at the beginning, after the server receives the access request, the server starts to create the database in the shared memory.

A deployment package for creating a database is first decompressed to a designated directory of the service, and four files are created in the designated directory after decompression, including a management tool, a configuration file, an identification file, and a data table structure definition file. In one embodiment, the management tool is an executable program, which is a management tool for the database, and the remaining 3 are control files, and the identification file can be set as a key file. For example, Fdbtool.exe is used as the management tool, filedb.cfg is used as the configuration file, filedb.ctl is used as the data table structure definition file, and filedb.key is used as a key file.

Secondly, the configuration file can be edited on the server, including configuring a shared memory space required by the database and a cache space required by the server.

Then a command “./fdbtool create database” is executed to complete a creation of an empty database.

Data creation is only performed once when a database system is initially deployed. After the database is created, a subsequent use process does not need to create the database again.

The server then sends a created identification file to the external program.
S300, according to the identification value in the identification file, a channel for the external program to access the shared memory is opened.

Specifically, in the present embodiment, when the database is just created, the identification value in the identification file is not yet assigned, or an initial value is No, and concrete assignment is provided and can be specifically set according to specific demand. Then, according to a determination of this identification value, the channel for the external program to access the shared memory is opened, so that the external program can access various data in the shared memory database.

Furthermore, in the present embodiment, according to the identification value in the identification file, a step of opening the channel for the external program to access the shared memory includes the following steps:
first, according to whether the shared memory has been created or not, the corresponding value assigned to the shared memory identification value in the identification file is yes or no;
when the database just starts to be created, the shared memory is not created yet, and the shared memory identification value in the identification file is not assigned, or the initial value of the shared memory identification value is initially assigned a value of No; when the database starts initialization, the database can read the shared memory identification value from the identification file, and opens the shared memory by determining the identification value. When the initialization is not completed, the identification value is not assigned or is not assigned by the initial value, and the database cannot open the shared memory, so at this time, the channel for the external program to access the shared memory cannot be opened. If the shared memory in an operating system has been created, the shared memory identification value in the identification file can be assigned by yes, and now the database can open shared memory, for example, the identification value can also be set to 0 or 1, “0” represents assignment by no, “1” identifies assignment by yes. In the present embodiment, the operating system comprises a linux system or a unix system, but the present application does not limit the operating system, and any operating system that can establish the shared memory is included.

Furthermore, in the present embodiment, according to the shared memory is or has not been created, after a step of being assigned as yes or no corresponding to the shared memory identification value in the identification file, also includes the following steps.

First, if the identification value in the identification file received by the external program is no, the database is controlled to read a first preset space of the shared memory in the configuration file.

Secondly, a shared memory of a first preset space is created according to the management tool in the database;

Finally, the channel for the external program to access shared memory is opened.

Specifically, if the identification value in the identification file received by the external program is no, it means that the database is still in initialization and has not been able to complete the creation of shared memory. When the database is initialized, the identification value in the identification file can be obtained first. If the identification value cannot be obtained or the identification value is no, the database cannot open the shared memory and determine that the shared memory does not exist. At this moment, the service controls the database to read the first preset space of the shared memory in the configuration file. In the present embodiment, the configuration file has recorded the startup control parameters of the database, for example, the first preset space of the shared memory that needs to apply for, or the database needs a buffer space of the service. The size of the first preset space is specifically set according to an industry or specific demand of a database application, and is not specifically limited in the present embodiment.

After the server obtains the first preset space of the shared memory, it creates a shared physical memory of the first preset space according to the management tool in the database.

After the shared memory is created, the database will first be initialized, mainly including initialization of transaction management and storage management. Furthermore, in the present embodiment, after the shared memory is created, the shared memory identification value in the identification file can also be synchronously updated to yes, so that the shared memory identification value obtained by other subsequent external programs is yes, and the data in the shared memory database can be directly accessed.

After initialization is completed, the database will create each data table object in turn, and also create each index object within each data table object.

Secondly, the database will also read the data table structure definition file and load all the contents in the data table structure definition file into the shared memory; then the database will create a control structure for each data table object and initialize various control information of the data table object (for example, including setting a record function to 0 and initializing a read-write lock), so that each data table in the database is stored in the shared memory.

After the database is created, the server opens the channel for the external program to access the shared memory.

Furthermore, in the embodiment, a step of creating the shared memory with the first preset space according to the management tool in the database includes:
according to the management tool, at least one second preset space of shared memory is allocated to each preset table object in the database, and the second preset space is smaller than the first preset space.

Specifically, the server allocates at least one second preset space of shared physical memory to each preset data table object according to the management tool in the database. The second preset space is smaller than the first preset space of the entire database. In one embodiment, the second preset space is set to be less than or equal to 4 MB, preferably equal to 4 MB. After the server allocates shared memory to each data table object, the database startup in the shared memory has been completed, and each table object is in a usable state in the database, and can accept data access from external programs at any time.

Secondly, if the identification value in the identification file received by the external program is yes, then the channel for the external program to access the shared memory is opened.

If the identification value in the identification file received by the external program is yes, it means that the shared physical memory and the database in the operating system have been created, so after the server opens the channel for the external program to access the shared memory, the external program can access various data in the database in the shared memory.

By using the identification value of the shared memory in the identification file as the channel for the external program to access the shared memory, the time waste caused by having to perform socket communication on every access is saved, and there is no need for the shared memory database service process to be online. It not only saves an access time of the memory database, improves an overall access efficiency of the database, but also improves a stability of the database system.
S400, the shared memory is mapped into the virtual address space of the external program according to a virtual address of the external program, and the database is loaded into the external program in a manner of a dynamic library or a static library.

Specifically, in the present embodiment, when the external program is accessing the database in the shared memory, the service can map each physical block of the whole shared memory and the physical address of each physical block to a virtual address space of the external program according to the virtual address of the external program, and each data table in the database has been loaded into the external program with the form of dynamic library or static library. At this moment, the program of the external program can access the database in the mode of accessing the data inside itself, greatly accelerating an access speed, improving an efficiency of data access and data processing.
S500, the database is controlled to exchange data with the external program in the shared memory.

Specifically, in the present embodiment, when the program of a terminal of the external program accesses the database, the database and the external program perform various data interactions in the shared memory.

Furthermore, in the present embodiment, after a step of controlling the database to exchange data with the external program in the shared memory, the method includes the following steps.
S600, the external program is controlled to access the database to read and write data in the shared memory.

Specifically, in the present embodiment, the external program and the database carrying out data interaction in the shared memory, mainly includes that the external program carries out a read-write data operation when accessing the database, and the read-write data operation of the external program accessing the database is to read and write data in the shared memory. At this moment, the external program can carry out the read-write operation of data in a mode that the physical memory carries out a read-write in the external program, thus improving the experience of the read-write operation of the external program.

In the present embodiment, the read-write operation of the external program includes the following basic data operations.

Data query (DQL): using commands including SELECT and WHERE command;
Data manipulation (DML): using commands including INSERT, UPDATE, and DELETE command;
Data definition (DDL): using commands including CREATE, DROP, and TRUNCATE (truncate) command;
Data control (DCL): uses commands including COMMIT and ROLLBACK command.
S700, the database is controlled to dynamically expand or release the shared memory used by the external program.

Specifically, in the present embodiment, the server can also control the database to dynamically expand or release the shared memory used by the external program; when the external program is performing an operation of adding or deleting data, the shared memory occupied by the database will become larger or smaller. In order to improve the efficiency of using the shared memory, the server will dynamically expand or release the data tables in the database that have operations of adding or deleting data according to a mapping relationship between the shared memory and the virtual address space in the external program.
S800, when the external program exits, a link between the external program and the shared memory is disconnected, and an access connection between the external program and the database can be disconnected.

Specifically, in the embodiment, when the external program needs to exit after completing various read-write data operations in the database, the link between the external program and the shared memory is disconnected, and the access connection between the external program and the database can be disconnected without any other operations or communications.

When the service no longer needs to use the database temporarily, the service can use the management tool to delete the database, and at this moment, the server can delete the data in the entire database by deleting the shared memory. If there is also an external program to need to access the data repeatedly or intensively later, the initialization of the database can be performed again, and it can be used normally.

In addition, in the embodiment, after a step of invoking the preset API interface to obtain the access request sent by the external program, the following steps includes:
S210, according to concurrent access requests, concurrently sending the identification files in the database to each external program, so that each external program waiting for access to the shared memory according to the identification value in the identification file;
S310, according to the identification value in the identification file, concurrently opening the channels for each external program accessing the shared memory;
S410, concurrently mapping the shared memory into the virtual address space of each external program, and the database being concurrently loaded into each external program in a manner of a dynamic library or a static library;
S510, controlling the database and each external program to concurrently perform data exchange in the shared memory.

Specifically, the above content mainly describes a method for a single external program to access the shared memory database. In the present embodiment, the shared memory database can also realize concurrent access. Since the shared memory in the operating system of the present embodiment allows multiple processes to perform concurrent access, when multiple external program applications simultaneously open the shared memory database, concurrent access to the database is realized, and data interaction is performed. The specific content refers to the content of the above-mentioned single external program accessing the database, which will not be repeated here.

In the embodiment, the server and the external program can be set in the same device, or they can be set separately in different devices, such as a server device and program terminal of multiple external devices. A shared memory database is set in the server device, and the programs of multiple external devices access the shared memory database of the server.

When the database on the server and the external program are on the same device, since the shared memory is accessed directly using the identification value in the identification file, there is no need to use the shared memory service process. The external program can access the contents of the shared memory database more quickly and there is no need to communicate and transmit over the network, which greatly improves the access speed and the efficiency of the external program accessing the database to perform data reading and writing operations.

In addition, the present embodiment also provides a method for accessing a shared memory database, which is applied to a server and includes the following steps:
invoking the preset API interface to obtain the access request sent by a program of a client;
according to the access request, sending the identification file in the database to the client, so that the client program waits for access to the shared memory according to the identification value in the identification file;
according to the identification value in the identification file, opening the channel for the client program to access the shared memory;
according to the virtual address of the client program, mapping the shared memory into the virtual address space of the client program, and the database is loaded into the client program in a manner of a dynamic library or a static library;
controlling the database and the client program to perform data interaction in the shared memory.

In the embodiment, the external program is installed in the client device, and the client program accesses the shared memory data on the server.

Furthermore, after a step of controlling the database and the client program to perform data interaction in the shared memory, the following steps are also included:
controlling the client program to access the database to read and write data by reading and writing data in the shared memory;
controlling the database to dynamically expand or release the shared memory used by the client program;
when the client program exits, disconnecting the link between the client program and the shared memory, and disconnecting the access connection between the client program and the database.

When the server and the external program are set in different devices, since the external program directly uses the identification value in the identification file to access the shared memory, there is no need for the shared memory service process to be online. The external program can access the content in the shared memory database more quickly, which speeds up the access to the shared memory. There is no need to worry about a running status of the shared memory service process, thereby improving the stability of the database system.

The beneficial effects of this embodiment compared with the prior art are illustrated as follow.

In the embodiment, according to the access request of the external program, the server sends the identification file in the database to the external program, the external program obtains the channel to access the shared memory according to the identification value in the identification file, and then directly maps the shared memory to the virtual address space of the external program, the database is loaded into the external program in a manner of a dynamic library or a static library, thereby realizing direct access and read-write data operations to the shared memory database, avoiding the time waste caused by having to perform socket communication for each access. Simultaneously, the technical solution of the embodiment does not require the shared memory database service process to be online, which not only saves the access time of the memory database, but also enables concurrent access by multiple applications, improves the overall database access efficiency, and improves the stability of the database system.

It should be understood that an order of executing each step in the above embodiment does not mean the execution order. The execution order of each process should be determined by its function and internal logic, and should not constitute any limitation on the implementation process of the embodiment of the present application.

### Embodiment 2

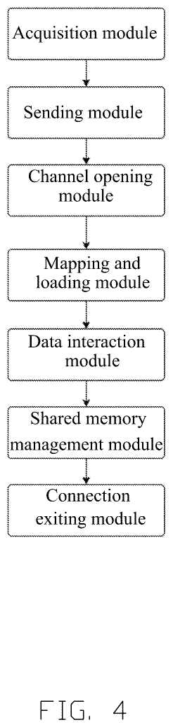

Corresponding to the method for accessing a shared memory database described in the above embodiment, FIG. 4 shows a structural block diagram of the device for accessing the shared memory database provided in the embodiment of the present application. For ease of explanation, only the part related to the embodiment of the present application is shown.

In a second aspect, as shown in FIG. 4, the embodiment provides a device for accessing a shared memory database, including:
an acquisition module, used to call a preset API interface to obtain an access request sent by an external program;
a sending module, used to send the identification file in the database to the external program according to the access request, so that the external program waits for access to the shared memory according to the identification value in the identification file;
a channel opening module, used to open the channel for the external program to access the shared memory according to the identification value in the identification file;
a mapping and loading module, used to map the shared memory into the virtual address space of the external program according to the virtual address of the external program, and the database being loaded into the external program in a manner of a dynamic library or a static library;
a data interaction module, used to control the database and the external program to perform data interaction in the shared memory;
a shared memory management module, used to control the external program to access the database to read and write data in the shared memory, and control the database to dynamically expand or release the shared memory used by the external programs;
a connection exiting module, used to disconnect the link between the external program and the shared memory when the external program exits, and then disconnect the connection between the external program and the database.

The present embodiment provides a device for accessing data by a shared memory, through the access request according to the external program, the server sends the identification file in the database to the external program, and the external program obtains the channel to access the shared memory according to the identification value in the identification file, and then directly maps the shared memory to the virtual address space of the external program, and the database is loaded into the external program in a manner of the dynamic library or a static library, thereby realizing direct access and read and write operations to the shared memory database, avoiding the time waste caused by socket communication for each access.

At the same time, the technical solution of the embodiment does not require the shared memory database service process to be online, which not only saves the access time of the memory database, but also enables concurrent access by multiple applications, thereby improving the overall database access efficiency and the stability of the database system.

It should be noted that the information interaction, execution process, etc. between the above-mentioned devices/units are according to the same concept as the method embodiment of the present application. Their specific functions and technical effects can be found in the method embodiment section and will not be repeated here.

Those skilled in the art can clearly understand that for the convenience and simplicity of description, only the division of the above-mentioned functional units and modules is used as an example for illustration. In actual applications, the above-mentioned functions can be assigned to different functional units and modules as needed, that is, the internal structure of the device can be divided into different functional units or modules to complete all or part of the functions described above. The functional units and modules in the embodiments can be integrated into one processing unit, or each unit can exist physically separately, or two or more units can be integrated into one unit. The above-mentioned integrated unit can be implemented in a manner of hardware or in a manner of software functional units. In addition, the specific names of the functional units and modules are only for the convenience of distinguishing each other, and are not used to limit the scope of protection of this application. The specific working process of the units and modules in the above-mentioned system can refer to the corresponding process in the aforementioned method embodiment, and will not be repeated here.

### Embodiment 3

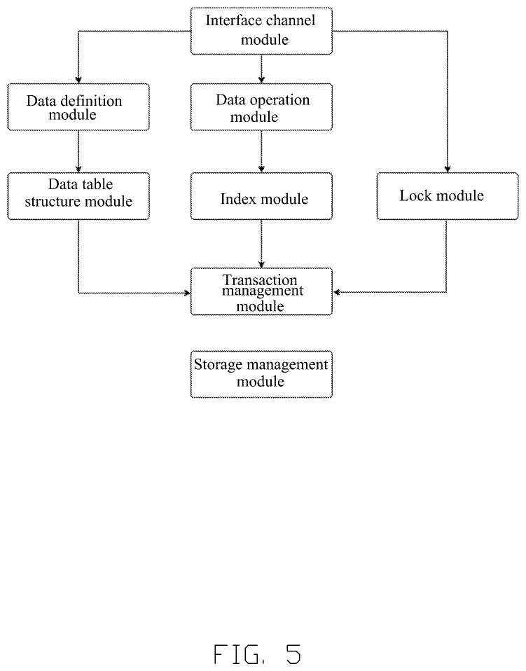

In a third aspect, as shown in FIG. 5, the embodiment provides a shared memory database system for access by multiple external programs, including:
an interface channel module, used to obtain the access requests from various external programs and provide access channels to the shared memory to various external programs in a manner of identification files;
a data definition module, used to perform initial configuration, table creation, table deletion, and index creation operations according to the operation commands output by the interface channel module;
a data table structure module, used to manage information of data table structure according to commands output by the data definition module;
a data operation module, used to perform data read and write operations according to the operation commands output by the interface channel module;
an index module, used to organize data according to the operation commands output by the data operation module;
a lock module, used to synchronously manage concurrent data access operations to ensure data consistency when multiple external programs access data in the shared memory;
a transaction management module, used to manage a concurrency control of each transaction in the database system;
a storage management module, used to dynamically manage the shared memory after each external program loads the database.

Specifically, in the present embodiment, the interface channel module is different from traditional shared memory database access interface. After the interface channel module of the embodiment obtains the access request of each external program, it uses the identification file to provide each external program with an access channel to the shared memory. It determines whether to open the channel for the external program to access the shared memory according to the shared memory identification value in the identification file. The identification file is the entry file of the database. The identification file can be set as a key file. The identification file includes the identification key value of whether to access the shared memory of the database.

The data definition module is used to perform initial configuration, create tables, delete tables and create indexes according to the operation commands output by the interface channel module, so as to facilitate the creation of a database and each data table object in the database.

The data table structure module is used for managing the information of the data table structure according to the commands output by the data definition module. The data table structure is an object structure used to record various control information of the data table, including table name, serial number, application type, field definition information list, index definition list, storage manager, lock, counter and other information. The data table structure definition file records the definition information of each data table (such as table type, name, serial number, table creation statement, data row length, maximum number of rows), field information list (such as field name, serial number, data type, maximum length, whether it is fixed length, whether it is allowed to be empty), index information list. During initialization, the system will create data table objects according to the definition information of each table. Among them, the counter is used to record various status information of the table, such as the current number of real-time data in the table, the high water mark of the table space, etc. The transaction management module will access the value of the counter and modify these counters.

The data table structure module also includes database control information, and the database control information is used to record various counter information such as the number of database tables, read-write locks, storage area size, and data starting address.

The data table structure module also includes data table objects, and the data table objects are the embodiment of each data table in the database and are used to record the definition information of each table (imported from the table structure definition file when the system is initialized), control information (the actual number of rows in the current table, read-write locks, etc.) and related data records (such as index information and data storage area information).

The data operation module performs data reading and writing operations according to the operation commands output by the interface channel module; since the contents of the entire database are stored in the shared physical memory with continuous physical addresses allocated by the operating system, the shared memory area is a physical embodiment of the database in the operating system.

The index module organizes data according to the operation command output by the data operation module. The index module includes index objects, and the index objects used in the data table to establish “indexes” for the data row, so as to realize a fast search operation for the data row. The index objects include index definition information (index type, name, uniqueness, field list, index key length, node size, etc.), B+ tree control information (B+ root node pointer, minimum leaf node pointer and total number, etc.) and index storage area information.

The lock module is used to synchronously manage concurrent data access operations to ensure data consistency when multiple external programs access data in the shared memory.

For example, it is used to perform synchronous locking management on concurrent data access operations and unlock the data after the operation is completed to ensure data consistency when multiple external programs access data in a shared memory.

The transaction management module is used to manage the concurrency control of each transaction in the database system. The transaction management module manages the transaction information in the database, including the online transaction list, the latest transaction ID and the transaction Undo log buffer.

The storage management module is used to dynamically manage the shared memory after each external program is loaded into the database. The storage management module is also used to record the system storage space allocation information (such as memory block size, total number of blocks, number of remaining blocks, high water mark and recycling list pointer), manage the dynamic allocation and dynamic release of the data storage space of each object in the entire database, and realize the virtualization of object data storage space.

### Embodiment 4

In a fourth aspect, the embodiment provides a server, including:
a memory, a processor, and a computer program stored in the memory and executable on the processor, wherein when the processor executes the computer program, the method for accessing a shared memory database as described in any one of the first aspects above is implemented.

### Embodiment 5

In a fifth aspect, the embodiment provides a computer-readable storage medium, wherein the computer-readable storage medium stores a computer program, and when the computer program is executed by a processor, the method for accessing the shared memory database as described in any one of the first aspects above is implemented.

### Embodiment 6

In a sixth aspect, the embodiment provides a computer program product. When the computer program product runs on a terminal device, the terminal device executes the method for accessing a shared memory database as described in any one of the first aspects above.

It can be understood that the beneficial effects of the second to sixth aspects mentioned above can be found in the relevant description of the first aspect mentioned above, and will not be repeated here.

A method for accessing a shared memory database provided in an embodiment of the present application can be applied to terminal devices such as mobile phones, tablet computers, wearable devices, vehicle-mounted devices, augmented reality (AR)/virtual reality (VR) devices, notebook computers, ultra-mobile personal computers (UMPCs), netbooks, personal digital assistants (PDAs), etc. The embodiment of the present application does not impose any restrictions on the specific types of terminal devices.

If the integrated unit is implemented in a manner of a software functional unit and sold or used as an independent product, it can be stored in a computer readable storage medium. According to such understanding, the application implements all or part of the flow in the above-mentioned embodiment method, and can be completed by instructing the relevant hardware through the computer program, and the computer program can be stored in the computer readable storage medium, and the computer program can realize the steps of the above-mentioned various method embodiments when being executed by a processor. Wherein, the computer program includes computer program codes, and the computer program codes can be a source code form, an object code form, an executable file or some intermediate forms, etc.

The computer readable medium may at least include: any entity or device capable of carrying the computer program code to the camera/terminal device, a recording medium, a computer memory, a read-only memory (ROM), a random access memory (RAM), an electric carrier signal, a telecommunication signal, and a software distribution medium. For example, a USB flash drive, a mobile hard disk, a magnetic disk, or an optical disk. In some jurisdictions, according to legislation and patent practice, the computer readable medium cannot be an electric carrier signal or a telecommunication signal.

In the above embodiments, the description of each embodiment has its own emphasis. For the parts that are not described or recorded in detail in a certain embodiment, reference can be made to the relevant descriptions of other embodiments.

Those of ordinary skill in the art will appreciate that the units and algorithmic steps of each example described in conjunction with the embodiments disclosed herein can be implemented with a combination of electronic hardware or computer software and electronic hardware. Whether these functions are performed in hardware or software mode depends on the specific application and design constraints of the technical solution. Professional and technical personnel can use different methods to implement the described functions for each specific application, but this implementation should not be considered to exceed the scope of the application.

In the embodiment provided by the present application, it should be understood that the disclosed device/network equipment and method can be realized by other modes. For example, the device/network equipment embodiment described above is only schematic, for example, the division of described module or unit is only a kind of logical function division, and other division mode can be arranged during actual implementation, for example, multiple units or components can be combined or can be integrated into another system, or some features can be ignored, or do not execute. Another point, the mutual coupling or direct coupling or communication connection shown or discussed can be through some interfaces, the indirect coupling or communication connection of device or unit can be electrical, mechanical or other form.

The units described as separate components may or may not be physically separated, and the components displayed as units may or may not be physical units, i.e., they may be located in one place, or they may be distributed on multiple network units. Some or all of the units may be selected according to actual needs to achieve the purpose of the present embodiment.

The above-described embodiments are only used to illustrate the technical solutions of the present application, rather than to limit them. Although the present application has been described in detail with reference to the aforementioned embodiments, a person of ordinary skill in the art should understand that the technical solutions described in the aforementioned embodiments can still be modified, or some of the technical features thereof can be replaced by equivalents. Such modifications or replacements do not deviate the essence of the corresponding technical solutions from the spirit and scope of the technical solutions of the embodiments of the present application, and should all be included in the protection scope of the present application.

1. A method for accessing a shared memory database, applied to a server, the method comprising:
invoking a preset application programming interface (API) interface and obtaining an access request sent by an external program;
sending an identification file in a database to the external program according to the access request, controlling the external program to wait to access a shared memory according to an identification value in the identification file;
according to the identification value in the identification file, opening a channel for the external program to access the shared memory;
mapping the shared memory to a virtual address space of the external program according to the virtual address of the external program, the database being loaded into the external program in a manner of a dynamic library or a static library;
controlling the database and the external program to perform a data interaction in the shared memory.

2. The method according to claim 1, wherein sending the identification file in the database to the external program according to the access request comprises:
creating the database using the server according to the access request, and creating the identification file according to the database;
sending the identification file to the external program.

3. The method according to claim 1, wherein opening the channel for the external program to access the shared memory according to the identification value in the identification file comprises:
assigning a value to the identification value of the shared memory in the identification file according to a determination result that represents whether the shared memory has been created;
in response that the identification value in the identification file received by the external program represents to be yes, opening the channel for the external program to access the shared memory.

4. The method according to claim 3, wherein after assigning the value to the identification value of the shared memory in the identification file according to the determination result that represents whether the shared memory has been created, the method further comprises:
in response that the identification value in the identification file received by the external program represents to be no, controlling the database to read a first preset space of the shared memory in the configuration file;
creating the shared memory with the first preset space according to a management tool in the database;
opening the channel for the external program to access the shared memory.

5. The method according to claim 4, wherein creating the shared memory with the first preset space according to the management tool in the database comprises:
allocating at least one shared memory with the second preset space to each preset table object in the database according to the management tool, the second preset space being smaller than the first preset space.

6. The method according to claim 1, after controlling the database and the external program to perform data interaction in the shared memory comprises:
controlling the external program to access the database to read and write data by reading and writing data in the shared memory;
controlling the database to dynamically expand or release the shared memory used by the external program;
in response that the external program exits, disconnecting an access connection between the external program and the database by disconnecting a link between the external program and the shared memory.

7. The method according to claim 1, wherein after invoking the preset API interface and obtaining the access request sent by the external program, the method further comprises:
concurrently sending the identification file in the database to each of the external programs according to each of access requests concurrently, controlling each of the external programs to wait to access the shared memory according to the identification value in the identification file;
concurrently opening the channel for each of the external programs to access the shared memory according to the identification value in the identification file;
concurrently mapping the shared memory to a virtual address space of each of the external programs, and the database being concurrently loaded into each of the external programs in a manner of a dynamic library or a static library;
controlling the database and each of the external programs to perform data interaction in the shared memory concurrently.

8-9. (canceled)

10. A server, comprising:
a processor;
a memory, storing a computer program, which when executed by the processor, cause the processor to:
invoke a preset application programming interface (API) interface and obtain an access request sent by an external program;
send an identification file in a database to the external program according to the access request, control the external program to wait to access a shared memory according to an identification value in the identification file;
according to the identification value in the identification file, open a channel for the external program to access the shared memory;
map the shared memory to a virtual address space of the external program according to the virtual address of the external program, the database being loaded into the external program in a manner of a dynamic library or a static library:
control the database and the external program to perform a data interaction in the shared memory.

11. A non-transitory storage medium having a computer program stored thereon, when the computer program is executed by a processor of a server, the processor is caused to perform a method for accessing a shared memory database, wherein the method comprises:
invoking a preset application programming interface (API) interface and obtaining an access request sent by an external program;
sending an identification file in a database to the external program according to the access request, controlling the external program to wait to access a shared memory according to an identification value in the identification file;
according to the identification value in the identification file, opening a channel for the external program to access the shared memory;
mapping the shared memory to a virtual address space of the external program according to the virtual address of the external program, the database being loaded into the external program in a manner of a dynamic library or a static library;
controlling the database and the external program to perform a data interaction in the shared memory.

12. The server according to claim 10, wherein sending the identification file in the database to the external program according to the access request comprises:
creating the database using the server according to the access request, and creating the identification file according to the database;
sending the identification file to the external program.

13. The server according to claim 10, wherein opening the channel for the external program to access the shared memory according to the identification value in the identification file comprises:
assigning a value to the identification value of the shared memory in the identification file according to a determination result that represents whether the shared memory has been created;
in response that the identification value in the identification file received by the external program represents to be yes, opening the channel for the external program to access the shared memory.

14. The server according to claim 13, wherein after assigning the value of yes or no to the identification value of the shared memory in the identification file according to whether the shared memory has been created or not, the method further comprises:
in response that the identification value in the identification file received by the external program represents to be no, controlling the database to read a first preset space of the shared memory in the configuration file;
creating the shared memory with the first preset space according to a management tool in the database;
opening the channel for the external program to access the shared memory.

15. The server according to claim 14, wherein creating the shared memory with the first preset space according to the management tool in the database comprises:
allocating at least one shared memory with the second preset space to each preset table object in the database according to the management tool, the second preset space being smaller than the first preset space.

16. The server according to claim 10, after controlling the database and the external program to perform data interaction in the shared memory comprises:
controlling the external program to access the database to read and write data by reading and writing data in the shared memory;
controlling the database to dynamically expand or release the shared memory used by the external program;
in response that the external program exits, disconnecting an access connection between the external program and the database by disconnecting a link between the external program and the shared memory.

17. The server according to claim 10, wherein after invoking the preset API interface and obtaining the access request sent by the external program, the method further comprises:
concurrently sending the identification file in the database to each of the external programs according to each of access requests concurrently, controlling each of the external programs to wait to access the shared memory according to the identification value in the identification file;
concurrently opening the channel for each of the external programs to access the shared memory according to the identification value in the identification file;
concurrently mapping the shared memory to a virtual address space of each of the external programs, and the database being concurrently loaded into each of the external programs in a manner of a dynamic library or a static library;
controlling the database and each of the external programs to perform data interaction in the shared memory concurrently.

18. The non-transitory storage medium according to claim 11, wherein sending the identification file in the database to the external program according to the access request comprises:
creating the database using the server according to the access request, and creating the identification file according to the database;
sending the identification file to the external program.

19. The non-transitory storage medium according to claim 11, wherein opening the channel for the external program to access the shared memory according to the identification value in the identification file comprises:
assigning a value to the identification value of the shared memory in the identification file according to a determination result that represents whether the shared memory has been created;
in response that the identification value in the identification file received by the external program represents to be yes, opening the channel for the external program to access the shared memory.

20. The non-transitory storage medium according to claim 19, wherein after assigning the value of yes or no to the identification value of the shared memory in the identification file according to whether the shared memory has been created or not, the method further comprises:
in response that the identification value in the identification file received by the external program represents to be no, controlling the database to read a first preset space of the shared memory in the configuration file;
creating the shared memory with the first preset space according to a management tool in the database;
opening the channel for the external program to access the shared memory.

21. The non-transitory storage medium according to claim 20, wherein creating the shared memory with the first preset space according to the management tool in the database comprises:
allocating at least one shared memory with the second preset space to each preset table object in the database according to the management tool, the second preset space being smaller than the first preset space.

22. The method according to claim 11, after controlling the database and the external program to perform data interaction in the shared memory comprises:
controlling the external program to access the database to read and write data by reading and writing data in the shared memory;
controlling the database to dynamically expand or release the shared memory used by the external program;
in response that the external program exits, disconnecting a link between the external program and the shared memory, disconnecting an access connection between the external program and the database.
